(19) United States
(12) Patent Application Publication
(10) Pub. No.: US 2014/0272233 A1
(43) Pub. Date: Sep. 18, 2014

(54) Mounting Element

(71) Applicant: John P. Downs, Colgate, WI (US)

(72) Inventor: John P. Downs, Colgate, WI (US)

(21) Appl. No.: 13/795,503

(22) Filed: Mar. 12, 2013

(51) Int. Cl. C09J 7/02

(52) U.S. Cl. CPC C09J 7/0232
USPC 428/40.1

(57) ABSTRACT

A mounting element is provided. The mounting element includes a layer, a first portion of adhesive, a second portion of adhesive, a first removable layer, and a second removable layer.

### BACKGROUND OF THE INVENTION

### Field of the Invention

The present invention relates generally to adhesives, and more particularly to mechanisms with adhesive and adhesive-free portions.

Various mechanisms to attach objects to surfaces are known. When nails, tacks, and staples are used for attachment, they tend to penetrate surfaces. Double-sided adhesive segments have been around for some time. However, in order to use such double-sided adhesive segments, the user must necessarily touch the adhesive, which can contaminate the adhesive which results in a less effective bond.

One approach uses stretch-releasing adhesive tape with an integral pull tab. An elongated length of single or double-sided stretch-releasing adhesive tape can be cut to a selected length with integral pull tabs for stretch removing the tape from a substrate. This approach is shown in U.S. Pat. No. 6,541,089, to Hamerski et al.

Another approach provides a stretch-releasing adhesive article for mounting on a wall surface that includes an elongated stretch-releasing adhesive strip. A backplate includes a protrusion arranged in overlapping relation with an adhesive strip non-adhesive contact surface that concentrates a force applied by a user in the region of the first end of the backplate in the region of the non-adhesive contact surface of the adhesive strip. This approach is shown in U.S. Pat. No. 7,276,272, to Mizuno et al.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

One embodiment of the invention relates to a mounting element. The mounting element includes a layer with a first side and a second side opposite the first side. The layer extends from a first end to a second end. The mounting element includes a first portion of adhesive. The first portion of adhesive includes a first side coupled to the first side of the layer and a second side.

The first portion of adhesive extends from a first end to a second end. The first portion of adhesive extends over a first portion of the first side of the layer proximate the first end of the layer. The second end of the first portion of adhesive is located between the first end and the second end of the layer. The mounting element includes a second portion of adhesive.

The second portion of adhesive has a first side coupled to the second side of the layer. The second portion of adhesive has a second side. The second portion of adhesive extends from a first end to a second end. The second portion of adhesive extends over a first portion of the second side of the layer proximate the first end of the layer. The second end of the second portion of adhesive is located between the first end and the second end of the layer.

The mounting element includes a first removable layer. The first removable layer extends from a first end to a second end. The first removable layer is coupled to the second side of the first portion of adhesive. A first force is required to peel the first removable layer from the first portion of adhesive. The first force is less than the shear strength of the layer proximate the second end of the first portion of adhesive.

The mounting element includes a second removable layer. The second removable layer extends from a first end to a second end. The second removable layer is coupled to the second side of the second portion of adhesive. A second force is required to peel the second removable layer from the second portion of adhesive. The second force is less than the shear strength of the layer proximate the second end of the second portion of adhesive.

Another embodiment of the invention relates to a mounting element. The mounting element includes a layer. The layer includes a first portion and a second portion. The layer includes a first side and a second side. The layer extends a first length from a first end to a second end. The layer extends a first width in a direction generally perpendicular to the direction of the length.

The mounting element includes a first portion of adhesive coupled to the first side of the first portion of the layer. The first portion of adhesive extends a second length. The second length is less than the first length. The second width is one of less than and equal to the first width. The mounting element includes a second portion of adhesive. The second portion of adhesive is coupled to the second side of the first portion of the layer. The second portion of adhesive extends a third length. The third length is less than the first length.

The second portion of adhesive extends a third width. The third width is one of less than and equal to the first width. The mounting element includes a first removable layer. The first removable layer is coupled to the first portion of adhesive. The first removable layer extends a fourth length. The fourth length is one of less than and equal to the first length. The first removable layer extends a fourth width. The fourth width is one of greater than and equal to the second width.

The mounting element includes a second removable layer. The second removable layer is coupled to the second portion of adhesive. The second removable layer extends a fifth length. The fifth length is one of less than and equal to the first length. The second removable layer extends a fifth width. The fifth width is one of greater than and equal to the third width. The first removable layer is configured to be removed from the first portion of adhesive. The second removable layer is configured to be removed from the second portion of adhesive.

Another embodiment of the invention relates to a mounting element. The mounting element includes a central layer. The central layer extends a first distance in a first direction. The mounting element includes a first adhesive portion. The first adhesive portion is coupled to one side of the central layer. The first adhesive portion extends in the first direction a second distance.

The mounting element includes a second adhesive portion. The second adhesive portion is coupled to the other side of the central layer. The second adhesive portion extends in the first direction a third distance. The third distance is equal to the second distance. The mounting element includes a first removable layer. The first removable layer is removably coupled to the first adhesive portion. The first removable layer extends in the first direction a fourth distance. The fourth distance is greater than the second distance and less than the first distance.

The mounting element includes a second removable layer. The second removable layer is removably coupled to the second adhesive portion. The second removable layer extends in the first direction a fifth distance. The fifth distance is greater than the third distance and less than the first distance.

Alternative exemplary embodiments relate to other features and combinations of features as may be generally recited in the claims.

### DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a mounting element;

FIG. 2 is a top view of an embodiment of a mounting element;

FIG. 3 is a cross-sectional view taken along the line 3-3 in FIG. 2;

FIG. 4 is a view showing the dimensions of various features of the embodiment of the mounting element shown in cross-section in FIG. 3;

FIG. 5 is a side view of an embodiment of a mounting element coupled to an exemplary surface;

FIG. 6 is a side view of an embodiment of a mounting element coupled to an exemplary surface with an exemplary object mounted to the mounting element;

FIG. 7 is a side view of the mounting element of FIG. 6 removed from the surface, with the mounting element being removed from the surface illustrated in broken lines;

FIG. 8 is a side view of the mounting element of FIG. 7 being re-coupled to a different location on the surface; and

FIG. 9 is a cross-sectional view of another embodiment of a mounting element.

### DETAILED DESCRIPTION OF AN EXEMPLARY EMBODIMENT

Before turning to the figures, an embodiment of a mounting element is provided. Generally, the mounting element includes a central layer and portions of adhesive on either side of the central layer. One of the portions of adhesive is configured to be applied to a surface to couple the central layer and the other portion of adhesive to the surface. An object or element to be coupled to the surface may be coupled to the other portion of adhesive to couple the element to the mounting element and to the surface.

In one embodiment, the mounting element includes an adhesive-free gripping portion to remove the mounting element and/or the object coupled to the surface from the surface. In one embodiment, the mounting element and the element to be coupled to a surface may then be re-coupled to the same or a different portion of the surface or to another surface. In one embodiment, the mounting element also includes removable layers each covering one of the portions of adhesive. When the mounting element is to be used, the removable layers may be removed from the portions of adhesive to allow access to the adhesive portions.

With reference to FIG. 1, an embodiment of a mounting element 20 is illustrated. The mounting element 20 includes a central layer 22. In one embodiment, the central layer 22 is generally rectangular. In one embodiment, the central layer 22 has generally rounded corners. In one embodiment, the central layer 22 is a film. In one embodiment, the central layer 22 is formed from polyethylene terephthalate (PET). In other embodiments, the central layer 22 is formed from other suitable plastics. In another embodiment, the central layer 22 is paper. In other embodiments, the central layer 22 may be formed from other suitable materials.

With reference to FIGS. 1 and 3, in one embodiment, the central layer 22 extends from a first end 24 to a second end 26. The central layer 22 includes a first side 28 and a second side 30.

With reference to FIG. 3, in one embodiment, coupled to the first side 28 of the central layer 22 is a first portion of adhesive 32. In one embodiment, the first portion of adhesive 32 is a hot melt adhesive. In another embodiment, the first portion of adhesive 32 is a polyurethane adhesive. In other embodiments, the first portion of adhesive 32 may be any suitable type of adhesive. The first portion of adhesive 32 has a first side 34 coupled to the central layer 22 and a second side 36 opposite the first side 34.

With further reference to FIG. 3, in one embodiment, the mounting element 20 also includes a first removable layer 38 coupled to the second side 36 of the first portion of adhesive 32. The first removable layer 38 includes a first side 40 coupled to the first portion of adhesive 32 and a second side 42 opposite the first side 40. In one embodiment, the second side 42 of the first removable layer 38 is non-tacky and/or non-sticky, e.g., does not adhere to other non-tacky and/or non-sticky objects or surfaces. In one embodiment, the first removable layer 38 generally covers the first portion of adhesive 32 and protects the first portion of adhesive 32, e.g., from contamination, etc., and allows for handling of the mounting element 20 when the mounting element 20 is not in use, e.g., when the first portion of adhesive 32 is not coupled to an object or a surface.

In one embodiment, the first removable layer 38 is formed from a suitable plastic material, e.g., polypropylene, polyethylene, etc. In other embodiments, the first removable layer 38 is formed from other suitable materials. In one embodiment, the first removable layer 38 is generally transparent. In another embodiment, the first removable layer 38 is translucent. In another embodiment, the first removable layer 38 is generally opaque.

With further reference to FIG. 3, in one embodiment, coupled to the second side 30 of the central layer 22 is a second portion of adhesive 44. In one embodiment, the second portion of adhesive 44 is the same type of adhesive as the first portion of adhesive 32 and/or has generally the same adhesive properties as the first portion of adhesive 32. In another embodiment, the second portion of adhesive 44 is a different type of adhesive than the first portion of adhesive 32 and/or has generally different adhesive properties than the first portion of adhesive 32. In one embodiment, the second portion of adhesive 44 is a hot melt adhesive. In another embodiment, the second portion of adhesive 44 is a polyurethane adhesive. In other embodiments, the second portion of adhesive 44 may be any suitable type of adhesive. The second portion of adhesive 44 has a first side 46 coupled to the central layer 22 and a second side 48 opposite the first side 46.

With further reference to FIG. 3, in one embodiment, the mounting element 20 also includes a second removable layer 50 coupled to the second side 48 of the second portion of adhesive 44. The second removable layer 50 includes a first side 52 coupled to the second portion of adhesive 44 and a second side 54 opposite the first side 52. In one embodiment, the second side 54 of the second removable layer 50 is non-tacky and/or non-sticky, e.g., does not adhere to other non-tacky and/or non-sticky objects or surfaces. In one embodiment, the second removable layer 50 generally covers the second portion of adhesive 44 and protects the second portion of adhesive 44, e.g., from contamination, etc., and allows for handling of the mounting element 20 when the mounting element 20 is not in use, e.g., when the second portion of adhesive 44 is not coupled to an object or a surface.

In one embodiment, the second removable layer 50 is formed from a suitable plastic material, e.g., polypropylene, polyethylene, etc. In other embodiments, the second removable layer 50 is formed from other suitable materials. In one embodiment, the second removable layer 50 is generally transparent. In another embodiment, the second removable layer 50 is translucent. In another embodiment, the second removable layer 50 is generally opaque.

With reference to FIG. 2, in one embodiment, each of the central layer 22, the first portion of adhesive 32, the first removable layer 38, the second portion of adhesive 44, and the second removable layer 50 extend generally the same width W1. In one embodiment, each of the central layer 22, the first portion of adhesive 32, the first removable layer 38, the second portion of adhesive 44, and the second removable layer 50 are generally rectangular. In one embodiment, each of the central layer 22, the first portion of adhesive 32, the first removable layer 38, the second portion of adhesive 44, and the second removable layer 50 have generally rounded corners. In one embodiment, the width W1 is between approximately 0.5 inches and approximately 2 inches. In another embodiment, the width W1 is between approximately 0.75 inches and approximately 1.5 inches. In another embodiment, the width W1 is approximately 1 inch.

With reference to FIG. 4, in one embodiment, the central layer 22 extends a first length L1 between its first end 24 and its second end 26. The first and second removable layers 38 and 50 extend a second length L2 in the direction between the first end 24 and second end 26 of the central layer 22. In one embodiment, the second length L2 is less than the first length L1. In one embodiment, this configuration allows a user to easily simultaneously grasp the first end 24 of the central portion 22 and either the first removable layer 38 or the second removable layer 50, e.g., both layers graspable without displacing the layers relative to one another, to remove, e.g., peel off the respective layer 38 and 50 from the respective portion of adhesive 32 and 44.

With further reference to FIG. 4, in one embodiment, the first portion of adhesive 32 and the second portion of adhesive 44 extend a third length L3 in the direction between the first end 24 and the second end 26 of the central layer 22. In one embodiment, the third length L3 is less than the second length L2. In one embodiment, the third length L3 is less than the first length L1. Thus, in one embodiment, the central layer 22 includes a portion that does not include adhesive, e.g., adhesive-free portion where both the first side 28 and second side 30 are uncovered by adhesive, shown in FIG. 4 as a grasping portion 56.

In one embodiment, the length L1 is between approximately ¾ inches and approximately 4 inches. In another embodiment, the length L1 is approximately inches. In one embodiment, the length L3 is approximately 1.5 inches. In one embodiment, the length L2 is approximately ⅛ inches longer than the length L2.

In one embodiment, the grasping portion 56 is configured to be handled by a user to locate the mounting element 20 without the user touching the first or second adhesive portions 32 and 44, e.g., allowing the user to move and locate the mounting element 20 without contaminating the adhesive portions 32 and 44, for example, by dirt and/or oil on the user's fingers, etc. In one embodiment, the grasping portion 56 also allows a user to remove the mounting element 20 from a surface or an object, as will be further described below.

With reference to FIGS. 4 and 5, in one embodiment, when the mounting element 20 is to be used, a user may grasp the grasping portion 56 of the central layer 22 and the first removable layer 38 proximate the grasping portion 56, e.g., a portion of the first removable layer 38 not in contact with the first portion of adhesive 32. In one embodiment, the first removable layer 38 may then be removed from the first portion of adhesive 32, e.g., peeled from the first portion of adhesive 32 in a direction from the first end 24 of the central layer 22 toward the second end 26 of the central layer 22, exposing the first portion of adhesive 32 for use, e.g., application to, for example, an object or surface.

In one embodiment, the first removable layer 38 is configured to be removed from the first portion of adhesive 32 without the first portion of adhesive 32 being removed from the central layer 22, e.g., the first portion of adhesive 32 has greater adhesion to the central layer 22 than to the first removable layer 38. In one embodiment, the first removable layer 38 is configured to be removed from the first portion of adhesive 32 without the central layer 22 tearing, rupturing, etc., e.g., the force to remove the first removable layer 38 from the first portion of adhesive 32 is less than the shear strength of the central layer 22, for example, the strength, e.g., shear strength, of the central layer 22 proximate an area 58 proximate the end of the first portion of adhesive 32 proximate the grasping portion 56.

With reference to FIG. 5, in one embodiment, once the first removable layer 38 is removed, the second side 36 of the first portion of adhesive 32 is exposed and may be applied to a surface or object, illustrated in FIG. 5 as a surface 60, for example a surface of a piece of paper. In one embodiment, the first portion of adhesive 32 is configured to be irremovably coupled to the surface 60, e.g., coupled such that the first portion of adhesive 32 cannot be removed from the surface 60 by force without for example destroying the paper with the surface 60, coupled such that the adhesive force between the first portion of adhesive 32 and the surface 60 is greater than the strength of the paper with the surface 60 and/or the strength, e.g., shear strength, of the central layer 22, etc. In one embodiment, the first portion of adhesive 32 is configured to be irremovably coupled to select materials and removably coupled to other materials, e.g., configured to be irremovably coupled to paper, while configured to be removably coupled to or unable to be coupled to, for example, a metal surface, a silicone surface, etc.

In another embodiment, the first portion of adhesive 32 is configured to be removably coupled to the surface 60, e.g., coupled such that the first portion of adhesive 32 can be removed from the surface 60, e.g., peeled from, etc., without for example, destroying the paper with the surface 60, coupled such that the adhesive force between the first portion of adhesive 32 and the surface 60 is less than the strength of the paper with the surface 60 and/or the strength, e.g., shear strength, of the central layer 22, for example, the strength, e.g., shear strength, of the central layer 22 proximate the area 58 proximate the end of the first portion of adhesive 32 proximate the grasping portion 56.

With further reference to FIGS. 4 and 5, in one embodiment, when the mounting element 20 is to be used, a user may grasp the grasping portion 56 of the central layer 22 and the second removable layer 50 proximate the grasping portion 56, e.g., a portion of the second removable layer 50 not in contact with the second portion of adhesive 44.

In one embodiment, the second removable layer 50 may then be removed from the second portion of adhesive 44, e.g., peeled in a direction from the first end 24 of the central layer 22 toward the second end 26, exposing the second side 48 of the second portion of adhesive 44 for use, e.g., application to, for example, an object or surface. In one embodiment, the second removable layer 50 is configured to be removed from the second portion of adhesive 44 without the second portion of adhesive 44 being removed from the central layer 22, e.g., the second portion of adhesive 44 has greater adhesion to the central layer 22 than to the second removable layer 50.

In one embodiment, the second removable layer 50 is configured to be removed from the second portion of adhesive 44 without the central layer 22 tearing, rupturing, etc., e.g., the force to remove the second removable layer 50 from the second portion of adhesive 44 is less than the strength, e.g., shear strength, of the central layer 22, for example, the strength, e.g., shear strength, of the central layer proximate the area 58 proximate the end of the first 32 and second 44 portions of adhesive and proximate the grasping portion 56.

With reference to FIG. 5, in one embodiment, the second removable layer 50 may be removed before or after the first removable layer 38 is removed and before or after the first portion of adhesive 32 is coupled to a surface or object.

With reference to FIG. 6, in one embodiment, once the second removable layer 50 is removed, the second side 48 of the second portion of adhesive 44 is exposed and may be applied to a surface or object, illustrated in FIG. 6 as a surface 65 of a piece of paper. In one embodiment, the second portion of adhesive 44 is configured to be irremovably coupled to the surface 65, e.g., coupled such that the second portion of adhesive 44 cannot be removed from the surface 65 by force without for example destroying the paper with the surface 65, coupled such that the adhesive force between the second portion of adhesive 44 and the surface 65 is greater than the strength of the paper with the surface 65 and/or the strength, e.g., shear strength, of the central layer 22, etc. In one embodiment, the second portion of adhesive 44 is configured to be irremovably coupled to select materials and removably coupled to other materials, e.g., configured to be irremovably coupled to paper, while configured to be removably coupled to or unable to be coupled to, for example, a metal surface, a silicone surface, etc.

In another embodiment, the second portion of adhesive 44 is configured to be removably coupled to the surface 65, e.g., coupled such that the second portion of adhesive 44 can be removed from the surface 65, e.g., peeled from, etc., without for example, destroying the paper with the surface 65, coupled such that the adhesive force between the second portion of adhesive 44 and the surface 65 is less than the strength of the paper with the surface 65 and/or the strength, e.g., shear strength, of the central layer 22, for example, the strength, e.g., shear strength, of the central layer 22 proximate the area 58 proximate the end of the first 32 and second 44 portions of adhesive and proximate the grasping portion 56.

In one embodiment, the first 32 and second portions of adhesive are both configured to be irremovably coupled to surfaces and/or objects. In one embodiment, the first 32 and second 44 portions of adhesive are both configured to be removably coupled to surfaces and/or objects. In another embodiment, one of the first 32 and second 44 portions of adhesive is configured to be irremovably coupled to a surface and/or object while the other of the first 32 and second 44 portions of adhesive is configured to be removably coupled to a surface and/or object. In one embodiment, the mounting element 20 provides a visual indication as to whether a portion of adhesive is configured to be removably or irremovably coupled to a surface and/or object.

With reference to FIG. 7, in one embodiment, the first portion of adhesive 32 is configured to be removably coupled to the surface 60. A user may grasp the grasping portion 56 which provides, e.g., a lever to peel the first portion of adhesive 32 away from the surface 60 to decouple the mounting element 20 from the surface 60, for example, the grasping portion 56 provides a place for a user to engage the mounting element 20 and allows the user to provide a removal force along the edge of the portion of adhesive to remove and/or peel the portion of adhesive from a surface. The mounting element 20 may then be reapplied to the same or a different portion of the surface 60, e.g., see FIG. 8, or to a different surface and/or object.

In one embodiment, the mounting element 20 includes a weakened portion, such as, e.g., a score line, perforated portion, etc., which allows for removal of the grasping portion 56 from the remainder of the central layer 22.

In one embodiment, the first portion of adhesive 32 is generally transparent. In another embodiment, the first portion of adhesive 32 is translucent. In another embodiment, the first portion of adhesive 32 is generally opaque.

In one embodiment, the second portion of adhesive 44 is generally transparent. In another embodiment, the second portion of adhesive 44 is translucent. In another embodiment, the second portion of adhesive 44 is generally opaque.

In one embodiment, the central layer 22 is generally transparent. In another embodiment, the central layer 22 is translucent. In another embodiment, the central layer 22 is generally opaque.

In some embodiments, the first removable layer may be peeled from the first adhesive portion, e.g., force applied along an edge of the coupling and/or bonded area between the first removable layer and the first adhesive portion. In some embodiments, the second removable layer may be peeled from the second adhesive portion, e.g., force applied along an edge of the coupling and/or bonded area between the second removable layer and the second adhesive portion. In some embodiments, the first adhesive portion may be peeled from a surface or object to which it is coupled, e.g., force applied along an edge of the coupling and/or bonded area between the first adhesive portion and the surface or object to which it is coupled. In some embodiments, the second adhesive portion may be peeled from a surface or object to which it is coupled, e.g., force applied along an edge of the coupling and/or bonded area between the second adhesive portion and the surface or object to which it is coupled.

In some embodiments, mounting elements may be used to couple pictures, photographs, and other artistic, commemorative, or decorative items to, for example, pages of scrapbooking books, posters, etc. In some embodiments, mounting elements may be useful for scrapbooking. In other embodiments, mounting elements may be useful for various other suitable uses, mechanisms, pursuits, etc.

FIG. 9 illustrates another embodiment of a mounting element 20′. The cross-sectional view is taken similar to the cross-sectional view of FIG. 3 of the embodiment of the mounting element 20 described above. The mounting element 20′ has various features similar to the mounting element 20 described above. Therefore, attention is given to the differences of mounting element 20′ from mounting element 20 in the description below.

With further reference to FIG. 9, the mounting element 20′ includes a first adhesive portion 32′ and a second adhesive portion 44′ on opposite sides of a central layer. In one embodiment, the first adhesive portion 32′ extends a length L4. In one embodiment, the second adhesive portion 44′ extends a length L5. In one embodiment, the length L5 is greater than the length L4.

The Figures illustrate the exemplary embodiments in detail, and it should be understood that the present application is not limited to the details or methodology set forth in the description or illustrated in the Figures. It should also be understood that the terminology is for the purpose of description only and should not be regarded as limiting. Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings of the subject matter described herein. Other substitutions, modifications, changes and omissions may also be made in the design, operating conditions and arrangement of the various exemplary embodiments without departing from the scope of the present invention. While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

For purposes of this disclosure, the term “coupled” means the mechanical joining of two components directly or indirectly to one another. Such joining may be stationary in nature or moveable in nature. Such joining may be achieved with the two components and any additional intermediate members being integrally formed as a single unitary body with one another or the two components and any additional member being attached to one another. Such joining may be permanent in nature or alternatively be removable or releasable in nature.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Other substitutions, modifications, changes and omissions may also be made in the design, operating conditions and arrangement of the various exemplary embodiments without departing from the scope of the present invention.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. A mounting element comprising:
a layer having a first side and a second side opposite the first side, the layer extending from a first end to a second end;
a first portion of adhesive having a first side coupled to the first side of the layer and a second side, the first portion of adhesive extending from a first end to a second end, the first portion of adhesive extending over a first portion of the first side of the layer proximate the first end of the layer, the second end of the first portion of adhesive located between the first end and the second end of the layer;
a second portion of adhesive having a first side coupled to the second side of the layer and a second side, the second portion of adhesive extending from a first end to a second end, the second portion of adhesive extending over a first portion of the second side of the layer proximate the first end of the layer, the second end of the second portion of adhesive located between the first end and the second end of the layer;
a first removable layer extending from a first end to a second end, the first removable layer being coupled to the second side of the first portion of adhesive, a first force being required to peel the first removable layer from the first portion of adhesive, the first force being less than the shear strength of the layer proximate the second end of the first portion of adhesive; and
a second removable layer extending from a first end to a second end, the second removable layer being coupled to the second side of the second portion of adhesive, a second force being required to peel the second removable layer from the second portion of adhesive, the second force being less than the shear strength of the layer proximate the second end of the second portion of adhesive.

2. The mounting element of claim 1, wherein the second end of the first removable layer is located closer to the second end of the layer than the second end of the first portion of adhesive.

3. The mounting element of claim 1, wherein the second end of the second removable layer is located closer to the second end of the layer than the second end of the second portion of adhesive.

4. The mounting element of claim 1, wherein the second side of the first portion of adhesive is configured to be applied to a non-tacky surface to couple the mounting element to the surface.

5. The mounting element of claim 4, wherein when the second side of the first portion of adhesive is applied to the non-tacky surface, the mounting element is removably coupled to the surface.

6. The mounting element of claim 1, wherein the first portion of adhesive is configured to be irremovably coupled to a surface and the second portion of adhesive is configured to be removably coupled to a surface.

7. The mounting element of claim 1, wherein the first removable layer is configured to be detached from the first portion of adhesive without removing the first portion of adhesive from the layer and without tearing the layer.

8. The mounting element of claim 1, wherein the second removable layer is configured to be detached from the second portion of adhesive without removing the second portion of adhesive from the layer and without tearing the layer.

9. A mounting element comprising:
a layer including a first portion and a second portion, a first side and a second side, the layer extending a first length from a first end to a second end, the layer extending a first width in a direction generally perpendicular to the direction of the length;
a first portion of adhesive coupled to the first side of the first portion of the layer, the first portion of adhesive extending a second length, the second length being less than the first length and second width being one of less than and equal to the first width;
a second portion of adhesive coupled to the second side of the first portion of the layer, the second portion of adhesive extending a third length, the third length being less than the first length, and a third width being one of less than and equal to the first width;
a first removable layer coupled to the first portion of adhesive, the first removable layer extending a fourth length, the fourth length being one of less than and equal to the first length, the first removable layer extending a fourth width, the fourth width being one of greater than and equal to the second width; and
a second removable layer coupled to the second portion of adhesive, the second removable layer extending a fifth length, the fifth length being one of less than and equal to the first length, the second removable layer extending a fifth width, the fifth width being one of greater than and equal to the third width;
wherein the first removable layer is configured to be removed from the first portion of adhesive; and
wherein the second removable layer is configured to be removed from the second portion of adhesive.

10. The mounting element of claim 9, wherein the fourth length is greater than the second length; and wherein the fifth length is greater than the third length.

11. The mounting element of claim 9, wherein the second length and the third length are the same; and wherein the fourth length and the fifth length are the same.

12. The mounting element of claim 9, wherein the first, second, third, fourth, and fifth widths are the same.

13. The mounting element of claim 9, wherein the first portion of adhesive is more strongly adhered to the layer than to the first removable layer; and wherein the second portion of adhesive is more strongly adhered to the layer than to the second removable layer.

14. The mounting element of claim 9, wherein upon removal of the first and second removable layers, the first portion of adhesive is configured to removably couple the mounting element to a first object having a non-tacky surface and the second portion of adhesive is configured to irremovably couple the mounting element to a second object having a non-tacky surface.

15. The mounting element of claim 9, wherein at least one of the layer, the first portion of adhesive, the first release layer, the second portion of adhesive, and the second release layer are translucent.

16. The mounting element of claim 9, wherein the layer, the first portion of adhesive, the first release layer, the second portion of adhesive, and the second release layer are translucent.

17. A mounting element comprising:
a central layer extending a first distance in a first direction;
a first adhesive portion coupled to one side of the central layer extending in the first direction a second distance;
a second adhesive portion coupled to the other side of the central layer extending in the first direction a third distance, the third distance being equal to the second distance;
a first removable layer removably coupled to the first adhesive portion extending in the first direction a fourth distance, the fourth distance being greater than the second distance and less than the first distance; and
a second removable layer removably coupled to the second adhesive portion extending in the first direction a fifth distance, the fifth distance being greater than the third distance and less than the first distance.

18. The mounting element of claim 17, wherein the fourth and fifth distances are the same.

19. The mounting element of claim 17, wherein when the first removable layer is removed from the first adhesive portion, the first adhesive portion is configured to couple the mounting element to a non-tacky surface such that the force necessary to decouple the first adhesive portion from the surface is less than the shear strength of the central layer and less than the force necessary to decouple the first adhesive portion from the central layer.

20. The mounting element of claim 17, wherein when the first removable layer is removed from the first adhesive portion, the first adhesive portion is configured to couple the mounting element to a non-tacky surface such that the force necessary to decouple the first adhesive portion from the surface is more than at least one of the shear strength of the central layer and the force necessary to decouple the first adhesive portion from the central layer.
